(19) United States
(12) Patent Application Publication
(10) Pub. No.: US 2012/0091319 A1
(43) Pub. Date: Apr. 19, 2012

(54) DRIVING METHOD FOR PHOTOSENSOR ARRAY PANEL

(76) Inventors: Ming-Ta Hsieh, Taipei County (TW); Shian-Jun Chiou, Taipei City (TW); Chien-Ming Lin, Kaohsiung County (TW); Chih-Chung Chen, Taichung County (TW); Huai-An Li, Taoyuan County (TW)

(21) Appl. No.: 12/965,438

(22) Filed: Dec. 10, 2010

(30) Foreign Application Priority Data
Oct. 13, 2010 (TW) 099134883

(51) Int. Cl. G01J 1/42

(52) U.S. Cl. 250/208.2

(57) ABSTRACT

A driving method for a photosensor array panel including a plurality of photosensor strips, a plurality of scan lines, at least a dummy photosensor strip, and at least a dummy scan line is provided. The photosensor strips are arranged side by side and located beside the dummy photosensor strip. The scan lines are electrically connected to the photosensor strips, and the dummy scan line is electrically connected to the dummy photosensor strip. The driving method includes the following steps. First, the photosensor strips are turned on in sequence through the scan lines. When none of the photosensor strips is turned on, the dummy photosensor strip will be turned on through the dummy scan line.

### CROSS-REFERENCE TO RELATED APPLICATION

This application claims the benefit of Taiwan Patent Application No. 099134883, filed on Oct. 13, 2010, which is hereby incorporated by reference for all purposes as if fully set forth herein.

### FIELD OF INVENTION

The present invention relates to a driving method for an input apparatus capable of operating an electronic device such as a mobile phone, a computer, or a personal digital assistant (PDA), and more particularly to a driving method for a photosensor array panel.

### RELATED ART

A photosensor array panel is an input apparatus for generating instructions by receiving or blocking light, and a conventional photosensor array panel is generally integrated with a display. For example, a photosensor array panel can be disposed in a display screen of an electronic device such as a mobile phone, a computer, or a PDA. A user can input instructions to the electronic device by using the photosensor array panel to operate the electronic device and view displayed images on the photosensor array panel.

A photosensor array panel generally includes a plurality of photosensor units arranged in a matrix and a plurality of scan lines. The photosensor units arranged in each of rows can form a photosensor strip, and each scan line is electrically connected to one of the photosensor strips and capable of turning on the photosensor strip. When the photosensor array panel is driven, a voltage signal is generally input to the scan lines in sequence, so as to turn on the photosensor strips in sequence. Thus, the photosensor array panel can input instructions to the electronic device by receiving or blocking light.

### SUMMARY OF THE INVENTION

The present invention is directed to a driving method for a photosensor array panel capable of driving the photosensor array panel by using a dummy photosensor strip and a dummy scan line.

The present invention provides a driving method for a photosensor array panel comprising a plurality of photosensor strips, a plurality of scan lines, at least a dummy photosensor strip, and at least a dummy scan line. The photosensor strips are arranged side by side and located beside the dummy photosensor strip. The scan lines are electrically connected to the photosensor strips, and the dummy scan line is electrically connected to the dummy photosensor strip. The driving method comprises the following steps. First, the photosensor strips are turned on in sequence through the scan lines. When none of the photosensor strips is turned on, the dummy photosensor strip will be turned on through the dummy scan line.

Based on the above, when none of the photosensor strips is turned on, the dummy photosensor strip will be turned on through the dummy scan line, so that in the present invention, the photosensor array panel is driven by not only using the scan lines and the photosensor strips, but also using the dummy scan line and the dummy photosensor strip at the same time.

In order to make the aforementioned features and advantages of the present invention more comprehensible, embodiments accompanied with figures are described in detail below.

### BRIEF DESCRIPTION OF THE DRAWINGS

The present invention will become more fully understood from the detailed description given herein below for illustration only, and thus are not limitative of the present invention, and wherein:

FIG. 1A is a schematic circuit diagram of a photosensor array panel applying a driving method according to an embodiment of the present invention;

FIG. 1B is a schematic view of variation of voltage signals input to scan lines and a dummy scan line in FIG. 1A with time;

FIG. 1C is a schematic view of variation of a sensor signal output by the photosensor array panel in FIG. 1A with time;

FIG. 2A is a schematic circuit diagram of a photosensor array panel applying a driving method according to another embodiment of the present invention; and

FIG. 2B is a schematic view of variation of voltage signals input to scan lines and dummy scan lines in FIG. 2A with time.

### DETAILED DESCRIPTION OF THE INVENTION

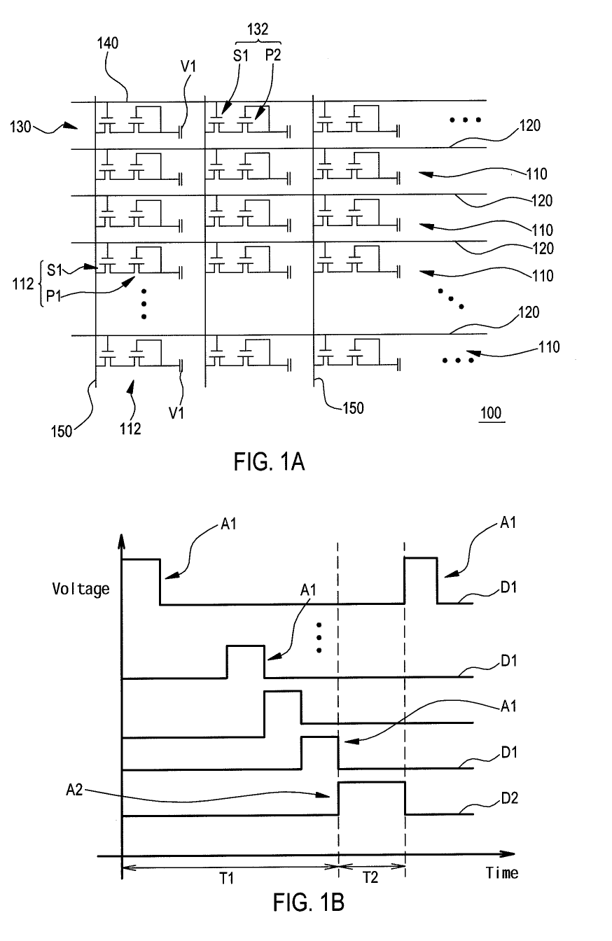

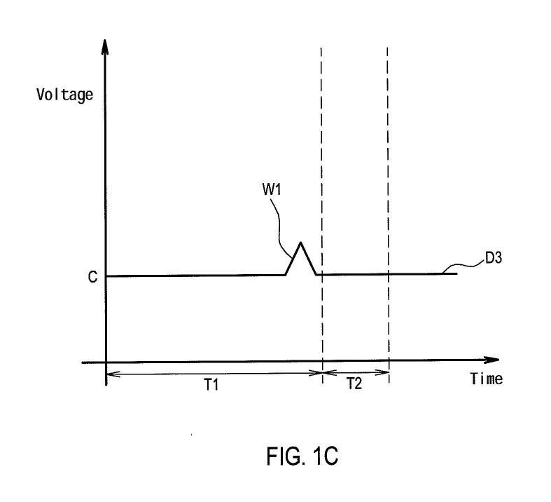

FIG. 1A is a schematic circuit diagram of a photosensor array panel applying a driving method according to an embodiment of the present invention. Referring to FIG. 1A, the driving method in this embodiment is applied to a photosensor array panel 100, and the photosensor array panel 100 may be applied to a display, for example, a flat panel display such as a liquid crystal display (LCD) or an organic light emitting diode display (OLED).

The photosensor array panel 100 includes a plurality of photosensor strips 110, a plurality of scan lines 120, a dummy photosensor strip 130, and a dummy scan line 140. The photosensor strips 110 are arranged side by side, and the scan line 120 may be the same as the dummy scan line 140 in structure, material, and function. Each photosensor strip 110 includes a plurality of photosensor units 112 arranged in a row, and the dummy photosensor strip 130 includes a plurality of dummy photosensor units 132 arranged in a row.

Each photosensor unit 112 may include a switch element S1 and a photosensor P1, and in the same photosensor unit 112, the switch element S1 is electrically connected to the photosensor P1. Taking FIG. 1A as an example, the switch element S1 may be a thin film transistor (TFT), and the photosensor P1 may be a phototransistor. A source of the switch element S1 is connected to a drain of the photosensor P1.

The scan lines 120 are electrically connected to the photosensor strips 110. In detail, each scan line 120 is electrically connected to gates of switch elements S1 in one of the photosensor strips 110. Furthermore, a source of each photosensor P1 is connected to a power source V1, and the source and a gate of each photosensor P1 are in electrical conduction with each other, as shown in FIG. 1A.

The dummy photosensor unit 132 may include a switch element S1 and a sensor P2. The switch element S1 is electrically connected to the sensor P2, for example, a source of the switch element S1 is connected to a drain of the sensor P2. The dummy scan line 140 is electrically connected to the dummy photosensor strip 130. For example, the dummy scan line 140 is electrically connected to gates of switch elements S1 in the dummy photosensor strip 130. Furthermore, a source of each sensor P2 is connected to the power source V1, and the source and a gate of each sensor P2 are in electrical conduction with each other.

As can be seen, the photosensor unit 112 and the dummy photosensor unit 132 are substantially the same in circuit structure and function. However, the photosensor P1 can receive light, while the sensor P2 cannot receive light. In detail, in this embodiment, the sensor P2 is shielded by a shielding layer, so that light from outside are blocked, thereby making it difficult for the sensor P2 to receive light. The shielding layer is, for example, a black matrix or a metal layer. Thus, on the whole, the dummy photosensor strip 130 basically does not provide a function of sensing light.

The photosensor strips 110 may be located beside the dummy photosensor strip 130. When the photosensor array panel 100 is a part of a display, all the photosensor strips 110 and the scan lines 120 are located in a display area, and both the dummy photosensor strip 130 and the dummy scan line 140 are located in a non-display area, so that an image shown by the display does not appear at the position where the dummy photosensor strip 130 is located.

FIG. 1B is a schematic view of variation of voltage signals input to scan lines and a dummy scan line in FIG. 1A with time. Referring to FIG. 1A and FIG. 1B, in the driving method in this embodiment, the photosensor strips 110 are turned on in sequence through the scan lines 120. The step of turning on the photosensor strips 110 in sequence includes: inputting a voltage signal D1 to the scan lines 120 in sequence, wherein the voltage signal D1 may be output from the power source V1.

In the embodiment as shown in FIG. 1A, the lowermost photosensor strip 110 may be turned on first. Next, an upper adjacent photosensor strip 110 is turned on. Accordingly, the photosensor strips 110 are turned on one by one in sequence from bottom to top, until the photosensor strip 110 closest to the dummy photosensor strip 130 is turn on. Thus, a sequence in which the photosensor strips 110 in FIG. 1A are turned on may be from bottom to top.

According to the sequence in which the photosensor strips 110 are turned on, the uppermost voltage signal D1 in FIG. 1B is input to the lowermost scan line 120 in FIG. 1A, and the lowermost voltage signal D1 is input to the scan line 120 closest to the dummy photosensor strip 130 in FIG. 1A. The intermediate voltage signals D1 are input to other scan lines 120 respectively.

The voltage signal D1 has a pulse A1. When the scan lines 120 receive the pulse A1, the scan lines 120 turn on the photosensor strips 110 electrically connected thereto. In a period T1 that the photosensor strips 110 are turned on in sequence, the lowermost scan line 120 first receives the pulse A1. Subsequently, the pulse A1 is input to the scan lines 120 one by one from bottom to top, until the scan line 120 closest to the dummy photosensor strip 130 receives the pulse A1.

In addition, in the period T1 that the photosensor strips 110 are turned on in sequence, one of the photosensor strips 110 is kept on. When another photosensor strip 110 is turned on, the photosensor strip 110 that is already turned on will be turned off. Therefore, the periods during any two photosensor strips 100 kept on do not overlap, so that the pulses A1 in the voltage signals D1 do not overlap in time, as shown in FIG. 1B.

In the period T1 that the photosensor strips 110 are turned on in sequence, one of the photosensor strips 110 is kept on, until another dummy photosensor strip 130 is turned on. In detail, when the photosensor strip 110 closest to the dummy photosensor strip 130 is just turned on, the photosensor strip 110 will be kept on until the dummy photosensor strip 130 is turned on. In other words, when the dummy photosensor strip 130 is turned on, the photosensor strip 110 continuously on will be turned off.

In the period T1, the dummy photosensor strip 130 is not turned on, and after the period T1, the dummy photosensor strip 130 is turned on through the dummy scan line 140, that is, the dummy photosensor strip 130 is turned on in a while except the period T1. It can be seen that when none of the photosensor strips 110 is turned on, only the dummy photosensor strip 130 is turned on. The step of turning on the dummy photosensor strip 130 includes inputting a voltage signal D2 to the dummy scan line 140. The voltage signal D2 may be output from the power source V1 and have a pulse A2.

In a period T2 that the dummy photosensor strip 130 is turned on, the dummy scan line 140 receives the pulse A2, so as to turn on the dummy photosensor strip 130. A pulse duration of the pulse A2 is basically equal to the duration of the period T2, so that within the period T2, the dummy photosensor strip 130 is kept on until any one of the photosensor strips 110 is turned on. Subsequently, the photosensor strips 110 are turned on in sequence again.

As can be seen, when all of the photosensor strips 110 are turned off, only the dummy photosensor strip 130 is turned on; and when the dummy photosensor strip 130 is turned off, only the photosensor strips 110 are turned on in sequence. Furthermore, when the photosensor array panel 100 operates, the photosensor strips 110 and the dummy photosensor strip 130 are turned on separately, in turn, and uninterruptedly, and the voltage signals D1 and D2 are input to the scan lines 120 and the dummy scan line 140 alternately and uninterruptedly.

It should be noted that when the photosensor array panel 100 is applied to a display (for example, a liquid crystal display) and is an active component array substrate for controlling pixels, the period T1 that the photosensor strips 110 are turned on in sequence may be a frame period, and the period T2 that the dummy photosensor strip 130 is turned on may be a blank time between two neighboring frame periods.

FIG. 1C is a schematic view of variation of a sensor signal output by the photosensor array panel in FIG. 1A with time. Referring to FIG. 1A and FIG. 1C, the photosensor array panel 100 may further include a plurality of readout lines 150. The readout lines 150 are crossed the scan lines 120 and electrically connected to the photosensor strips 110 and the dummy photosensor strip 130.

Each readout line 150 outputs a sensor signal D3, and FIG. 1C shows a sensor signal D3 output by one of the readout lines 150. According to the sensor signals D3 output by the readout lines 150, it can be judged that which photosensor unit 112 is illuminated by the light from outside, or it can be judged which photosensor unit 112 blocks the light. The light from outside may be emitted from a light pen.

For example, when the photosensor array panel 100 is illuminated by the light from outside, a peak W1 appears on the sensor signal D3. According to the time at which the peak W1 appears, and by using a clock, it can be determined which photosensor unit 112 on the readout line 150 is illuminated by the light. Thus, according to the sensor signal D3 output by each readout line 150, it can be determined which position in the photosensor array panel 100 is illuminated by the light from outside.

As can be seen, a user can control the photosensor array panel 100 by using light emitted from a light source such as a light pen, or by touching the photosensor array panel 100 with a finger or an object such as a stylus pen, so that the photosensor array panel 100 can input instructions to an electronic device (for example, a mobile phone, a computer or a PDA), thus operating the electronic device.

In addition, as the photosensor strips 110 and the dummy photosensor strip 130 are turned on separately, in turn, and uninterruptedly, when the photosensor array panel 100 operates, the readout lines 150 output sensor signals D3 continuously and stably, so that voltage values of the sensor signals D3 are substantially maintained greater than a constant C. Furthermore, in the period T2 that the dummy photosensor strip 130 is turned on, since the dummy photosensor strip 130 cannot sense the light, the voltage values of the sensor signals D3 are substantially equal to the constant C, as shown in FIG. 1C.

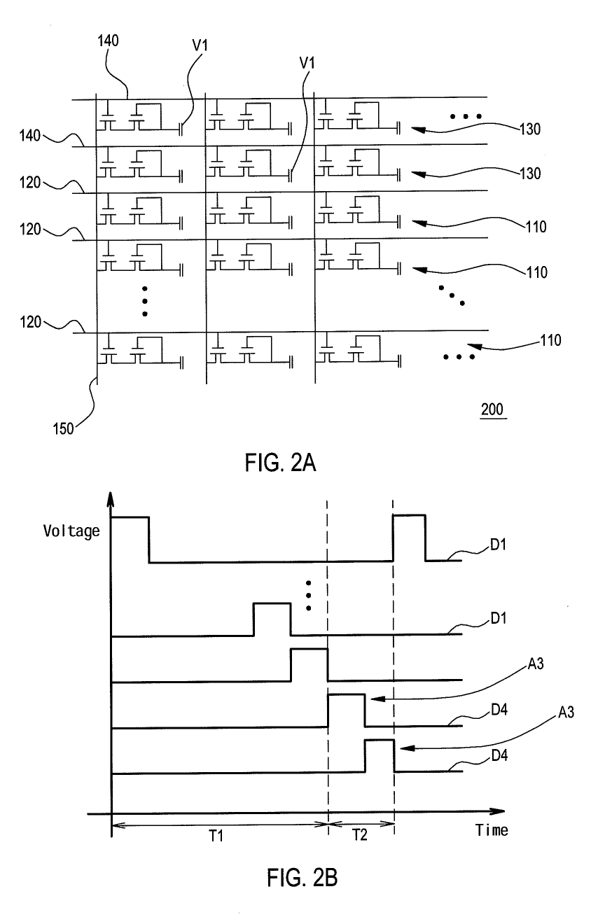

FIG. 2A is a schematic circuit diagram of a photosensor array panel applying a driving method according to another embodiment of the present invention. Referring to FIG. 2A, the driving method in this embodiment is applied to a photosensor array panel 200. The photosensor array panel 200 and the photosensor array panel 100 in the above embodiment have approximately the same circuit structures except that the photosensor array panel 200 includes a plurality of dummy photosensor strips 130 and a plurality of dummy scan lines 140, and the photosensor strips 110 may be located beside the dummy photosensor strips 130.

FIG. 2B is a schematic view of variation of voltage signals input to scan lines and dummy scan lines in FIG. 2A with time. Referring to FIG. 2A and FIG. 2B, the driving method in this embodiment is similar to the driving method in the above embodiment. For example, the photosensor array panel 200 further includes a plurality of photosensor strips 110 and a plurality of scan lines 120, and the scan lines 120 are electrically connected to the photosensor strips 110. The photosensor strips 110 are turned on in sequence through the scan lines 120. In addition, the manner that the photosensor strips 110 are turned on in sequence is the same as the above embodiment, so that the details will not be described hereinafter again.

However, the driving method in this embodiment and the driving method in the above embodiment are different in the manner of turning on the dummy photosensor strips 130. In detail, when none of the photosensor strips 110 is turned on, the dummy photosensor strips 130 are turned on in sequence through the dummy scan lines 140. When the dummy photosensor strips 130 are turned on in sequence, a voltage signal D4 is input to the dummy scan lines 140 in sequence. The voltage signal D4 may be output from the power source V1 connected to the dummy photosensor unit 132.

In the embodiment as shown in FIG. 2A, both numbers of the dummy photosensor strips 130 and the dummy scan lines 140 are two each, and in the period T2, the lower dummy photosensor strip 130 may be turned on first. Subsequently, the other dummy photosensor strip 130 is turn on. According to the sequence in which the dummy photosensor strips 130 are turned on, the upper voltage signal D4 in FIG. 2B is input to the lower dummy scan line 140 in FIG. 2A, and the lowermost voltage signal D4 is input to the upper dummy scan line 140 in FIG. 2A.

In detail, in the period T2 that the dummy photosensor strips 130 are turned on in sequence, the lower dummy scan line 140 first receives a pulse A3 of the voltage signal D4. Subsequently, the upper dummy scan line 140 receives the pulse A3. Thus, the lower dummy scan line 140 is turned on first, and the upper dummy scan line 140 is turned on last.

In the period T2 that the dummy photosensor strips 130 are turned on in sequence, one of the dummy photosensor strips 130 is kept on until the other dummy photosensor strip 130 is turned on. That is, when the other dummy photosensor strip 130 is turned on, the dummy photosensor strip 130 that is already turned on is turned off. Therefore, the periods during any of the dummy photosensor strips 130 kept on do not overlap, so that the pulses A3 in the voltage signals D4 do not overlap in time.

After the period T2, all of the dummy photosensor strips 130 are turned off, and the photosensor strips 110 are turned on in sequence through the scan lines 120 until the next period T2. In the next period T2, the dummy photosensor strips 130 are turned on in sequence again. As can be seen, the photosensor strips 110 and the dummy photosensor strips 130 are turned on separately, in turn, and uninterruptedly.

The photosensor array panel 200 may further include a plurality of readout lines 150, and the readout lines 150 are electrically connected to the photosensor strips 110 and the dummy photosensor strips 130. As the photosensor strips 110 and the dummy photosensor strips 130 are turned on separately, in turn, and uninterruptedly, when the photosensor array panel 200 operates, the readout lines 150 can also output sensor signals continuously and stably, so that the voltage values of the sensor signals are substantially maintained greater than a constant (as shown in FIG. 1C).

Based on the above, through the dummy scan lines and the dummy photosensor strips, when none of the photosensor strips is turned on, the dummy photosensor strips are turned on through the dummy scan lines, so that in the driving method for a photosensor array panel according to the present invention, not only the scan lines and the photosensor strips are utilized, but also the dummy scan lines and the dummy photosensor strips are further utilized.

Moreover, when the photosensor array panel operates, since the photosensor strips and the dummy photosensor strips are turned on separately, in turn, and uninterruptedly, the readout lines output sensor signals continuously and stably. Therefore, when the sensor signals are processed, simple filtering can be performed first. For example, the sensor signals pass through a capacitor to filter out noises of direct current components. Therefore, not only the sensing accuracy of the photosensor array panel can be improved, but also a follow-up work of processing the sensor signals is simplified.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A driving method for a photosensor array panel, wherein the photosensor array panel comprises a plurality of photosensor strips, a plurality of scan lines, at least a dummy photosensor strip, and at least a dummy scan line, the photosensor strips are arranged side by side and located beside the dummy photosensor strip, the scan lines are electrically connected to the photosensor strips, and the dummy scan line is electrically connected to the dummy photosensor strip, the driving method comprising the following steps:
turning on the photosensor strips in sequence through the scan lines, wherein in a period that the photosensor strips are turned on in sequence, one of the photosensor strips is kept on until another dummy photosensor strip is turned on; and
turning on the dummy photosensor strip through the dummy scan line when none of the photosensor strips is turned on, wherein in a period that the dummy photosensor strip is turned on, the dummy photosensor strip is kept on until any one of the photosensor strips is turned on.

2. The driving method for a photosensor array panel according to claim 1, wherein the step of turning on the photosensor strips in sequence comprises inputting a voltage signal to the scan lines in sequence.

3. The driving method for a photosensor array panel according to claim 1, wherein the step of turning on the dummy photosensor strip comprises inputting a voltage signal to the dummy scan line.

4. The driving method for a photosensor array panel according to claim 1, wherein both numbers of the dummy photosensor strips and the dummy scan lines are plural each, and when none of the photosensor strips is turned on, the dummy photosensor strips are turned on in sequence through the dummy scan lines.

5. The driving method for a photosensor array panel according to claim 4, wherein in a period that the dummy photosensor strips are turned on in sequence, one of the dummy photosensor strips is kept on until another dummy photosensor strip is turned on.

6. The driving method for a photosensor array panel according to claim 1, wherein the photosensor array panel further comprises a plurality of readout lines, the readout lines are crossed the scan lines and electrically connected to the photosensor strips and the dummy photosensor strip, each of the readout lines outputs a sensor signal, and in a period that the dummy photosensor strip is turned on, a voltage value of the sensor signal is substantially equal to a constant.
